(19) United States
(12) Patent Application Publication
(10) Pub. No.: US 2005/0064986 A1
(43) Pub. Date: Mar. 24, 2005

(54) Continuously variable friction roll toroidal drive

(75) Inventor: Eduard Ginglas, Horgau-Auerbach (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke AG, Muenchen (DE)

(21) Appl. No.: 10/990,969

(22) Filed: Nov. 18, 2004

Related U.S. Application Data
(63) Continuation of application No. PCT/EP03/04309, filed on Apr. 25, 2003.

(30) Foreign Application Priority Data
May 25, 2002 (DE) 102 23 425.6

(51) Int. Cl. F16H 15/38

(52) U.S. Cl. 476/40

(57) ABSTRACT

A continuously variable friction roll toroidal drive includes two variator disks which are rotatable about a common roll axis and which have tracks which are part of the circumferential surface of a torus concentric with the variator roll axis, and a plurality of rollers in contact with the tracks, each being mounted for rotation in a housing with which a support is associated. The axis of rotation of each roller being able to turn about an axis which is inclined at a certain angle to the center plane of the torus. The direction of the action of the support of each roller lies in the center plane of the torus. Each roller is mounted for rotation on a turning body. The turning body is mounted for turning in the housing, the axis of rotation of the turning body being inclined at a certain angle to the center plane of the torus.

### CROSS REFERENCE TO RELATED APPLICATIONS

This application is a continuation of International Patent Application No. PCT/EP03/04309, filed Apr. 25, 2003, designating the United States of America, and published in German as WO 03/100294 A1, the entire disclosure of which is incorporated herein by reference. Priority is claimed based on German patent application no. 102 23 425.6, filed May 25, 2002.

### BACKGROUND AND SUMMARY OF THE INVENTION

The invention relates to a continuously variable friction roll toroidal drive comprising two variator disks that are rotatable about a common roll axis and which have tracks which are part of the circumferential surface of a torus concentric with the variator roll axis, and in contact with the tracks is a plurality of rollers which are journaled each in a housing with which a support is associated connected with a hydraulically operated piston, the axis of rotation of each roller being able to turn about an axis which is inclined at a certain angle (castor angle) to the central plane of the torus.

A conventional friction roll torus drive of this kind is represented in a side view in FIG. 6 and in a plan view in FIG. 7. FIG. 6 shows an output variator disk 1 and an input variator disk 2, which can rotate about a common variator roll axis 5. The input variator disk 2 is driven by a motor 3 through a shaft 4. The two variator disks 1 and 2 are provided with tracks 6 and 7 whose surfaces correspond to a portion of the circumferential surface of an imaginary torus the remainder of which is indicated by a broken line 8. The axis of this imaginary torus in this case corresponds to the common variator roll axis 5. A group of rollers 9, which usually comprises three rollers which are arranged at equal intervals around the roll axis 5, are frictionally engaged with the tracks 6 and 7 in order to transfer a torque from the input variator disk 2 to the output variator disk 1. In FIG. 6 one of these rollers 9 is shown, which is journaled with bearings in a housing 10, so that it can rotate about a roll axis 11. If the housing 10, and thus the roller 9, changes its orientation by turning in the direction of the arrow 12, then evidently the ratio of the speeds of the two variator disks 1 and 2 also varies. The variation of the angle of inclination of the roll axis 11 with respect to roll axis 5 permits a continuous variation of the transmission ratio of the output variator disk 1 to the input variator disk 2. A rod 13 connects the housing 10 with a piston 14 which is axially movable in a stationary hydraulic cylinder 15 and can turn to a limited extent.

A continuous drive of this kind operates properly whenever a hydraulic fluid in the cylinder 15 exerts a force on the piston 14, which in the state of equilibrium has to equalize the reaction force that originates from the resultant torque at the point of contact of the roller 9 with the tracks 6 and 7. The roller 9 changes its orientation of the angle of inclination of its axis of rotation 11 with respect to the variator roll axis 5 if the conditions of equilibrium of the applied forces are not satisfied.

The center point of the roller 9 must always follow the center circle of the torus, which in turn lies in the center plane M of the torus. For the reason to be given below, the rod 13, which defines the axis of rotation of the roller 9, is inclined at an angle C to the center plane M. In order for the roller 9 to be able to assume a stable transmission position on the basis of its degrees of liberty, the roll axis 11 of roller 9 must be able to intersect with the roll axis 5 of the variator disks 1 and 2. In case of a shift in the direction of action of the rod 13, the roller 9 comes out of its stable position and makes its adjustment. To be able to resume a new stable position, the angle C between the axis of roller 9 that is defined by the piston shaft 13 and the center plane M of the torus defined by the tracks 6 and 7 is necessary. This angle C, called the castor angle, makes it possible, due to kinematic rules, for the above-described roll axes 11 of the roller 9 to relocate independently its intersection with the variator roll axis 5 and achieve a stable position. The rule in this case is that the self-stabilization of the roller 9 increases with the increasing castor angle. The circumstance that the thrusting force produced by the piston 14 is inclined by the castor angle C toward the center plane M of the torus results, however, in an unequal thrusting force of roller 9 against the two variator disks 1 and 2. This unequal distribution of force increases with an increasing castor angle. As it appears from FIG. 7, the thrusting force exerted by piston 14 through rod 15 has a component in the direction of the variator roll axis 5. The roller 9 is therefore urged more strongly by the thrusting force produced by piston 14 against the input variator disk 2 than it is against the output variator disk 1. In order to assure a virtually slip-free transfer of force between the variator disks 1 and 2 and the rollers 9 a certain minimum contact force is necessary. Therefore the lower thrusting force is what determines the establishment of the thrusting force of the variator disks against one another. This signifies, however, that the rollers 9 are urged against the input variator disk 2 with a force too great for a proper transmission of force, which leads to definite losses of efficiency.

Another disadvantage of the introduction of the thrust for the rollers at an angle to the center plate M of the torus is an unfavorable positioning of the cylinder 15 in the drive, which can even necessitate a bent shape of the rod 13. But the consequence of such a bent shape of the rod 13 is that a tilting moment is applied to the piston 14.

The invention is addressed to the problem of creating a friction roll toroidal drive of this kind, in which the force necessary for the thrust of the rollers has no component in the direction of the variator roll axis.

This problem is solved by the invention in that the direction of the thrust of each roller lies in the central plane of the torus, that each roller is mounted for rotation on a turning body, and that the turning body is mounted for rotation in the housing, the swing axis of the turning body being inclined at a specific angle (castor angle) to the central plane of the torus.

The angular positioning of the swing axis of the turning body, which can be freely chosen structurally, with respect to the center plane of the torus, results in the kinematic prerequisite, so that when the turning body turns, the roll axis of the roller journaled thereon can intersect with the roll axis of the variator disks. Due to the separation of the castor angle and the direction of the thrust of this roller, it is possible to position the direction of the thrust of each roller in the center plane of the torus. Thus a uniform distribution of force in the contact point of each roller with the two variator disks is possible. This signifies a reduction of the thrust of the variator disks against the rollers and an increase in the overall efficiency.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a partially cut-away side elevation of a first embodiment of a friction roll toroidal drive,

FIG. 2 a plan view of the drive of FIG. 1,

FIG. 3 a partially cut-away perspective view of the drive of FIG. 1, and

FIG. 4 a representation similar to FIG. 3, but showing a variant embodiment,

FIG. 5 a representation similar to FIG. 3, but showing still another variant,

FIG. 6 a schematic side view of a conventional friction roll toroidal drive, and

FIG. 7 a schematic plan view of the drive of FIG. 6.

### DETAILED DESCRIPTION OF THE DRAWINGS

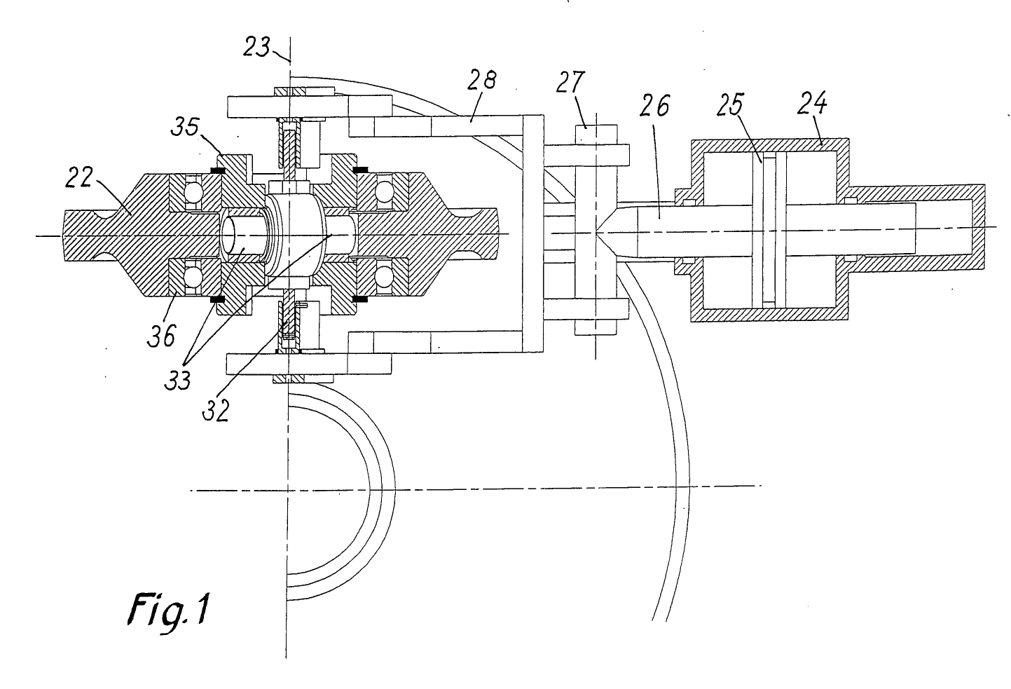

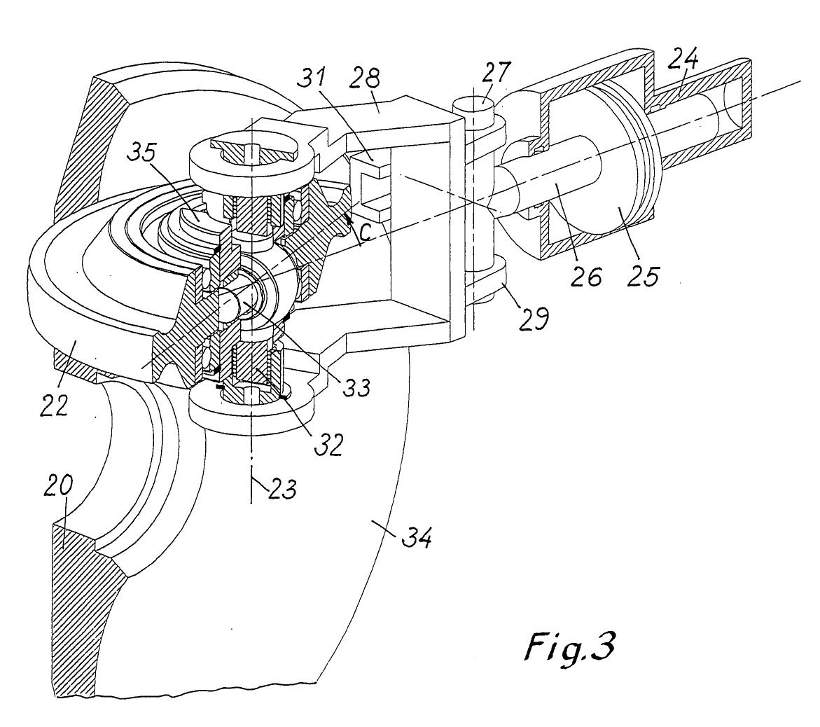

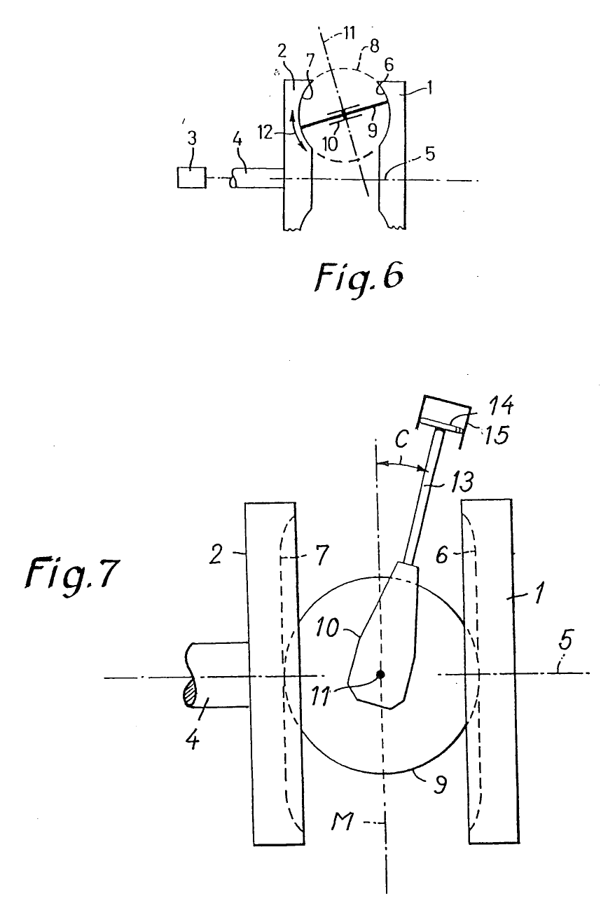

In FIGS. 1 to 3 is shown only one of the two variator disks 20 of a toroidal drive which can rotate about a variator roll axis 21. Also, only one of several rollers 22 is shown, which is in contact with the track 34 of the variator disk 20 and can rotate about a roller axis 23. Important to the invention is the manner in which each roller 22 is mounted in the associated housing and the way in which the housing is supported against the reaction force exerted by the roller in operation. As far as the other constructional and functional details of the toroid drive are concerned, see the introductory explanation of FIGS. 6 and 7.

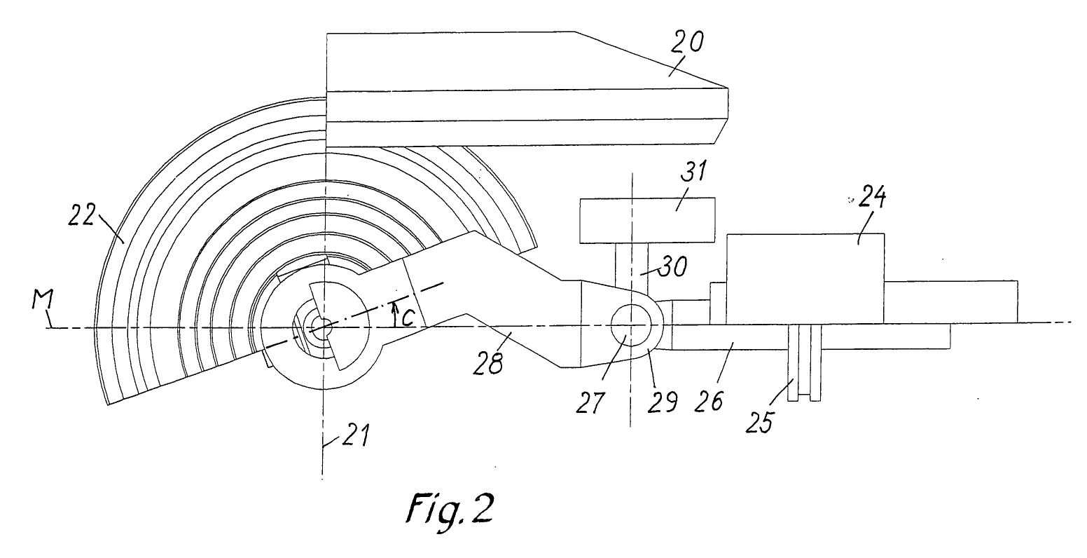

In a fixedly disposed cylinder housing 24 a piston 25 is arranged which can be acted upon bilaterally by a hydraulic fluid. The piston 25 is fastened on a piston shaft 26 which is guided for axial displacement in the cylinder housing 24. On the end of the portion of the piston shaft a link pin 27 is fastened. The housing of the roller 22 comprises a fork 28 which has two lugs 29 pointing away from the roller 22, through which the pin 27 rotatably passes. As it can be seen in FIG. 2, the axis of rotation of the fork 28 as defined by the pin 27 and the lugs 29 lies in the center plane M of the torus and is at right angles to the piston shaft 26. A guide pin 30 is fastened to the pin 27 or is made integral with it, and enters into a fixedly disposed straight guide 31. This straight guide 31 is parallel to the piston shaft 26 and thus permits axial displacement, but prevents any rotation thereof A pivot pin 32 is fastened for rotary adjustment in the fork 28. The axis of the pivot pin 32 is parallel to the axis of the pin 27 and it lies also in the center plane M of the torus. As it can be seen in FIG. 2, the long axis of the piston shaft 26 and the axis of the pin 32 are situated in the center plane M of the torus. The pivot pin 32 is provided with two journals 33 whose common axis is at an angle C, the so-called castor angle, to the center plane M of the torus. A turning body 35 is mounted for rotation on both of the journals 33. The roller 22 is mounted for rotation on the turning body 35 with a ball bearing 36. In operation, the turning body 35 and with it the roller 22 can turn about the axis defined by the two journals 33, so that the axis of rotation 23 of the roller can intersect with the variator roll axis 21 in order to assure the stable condition mentioned in the beginning.

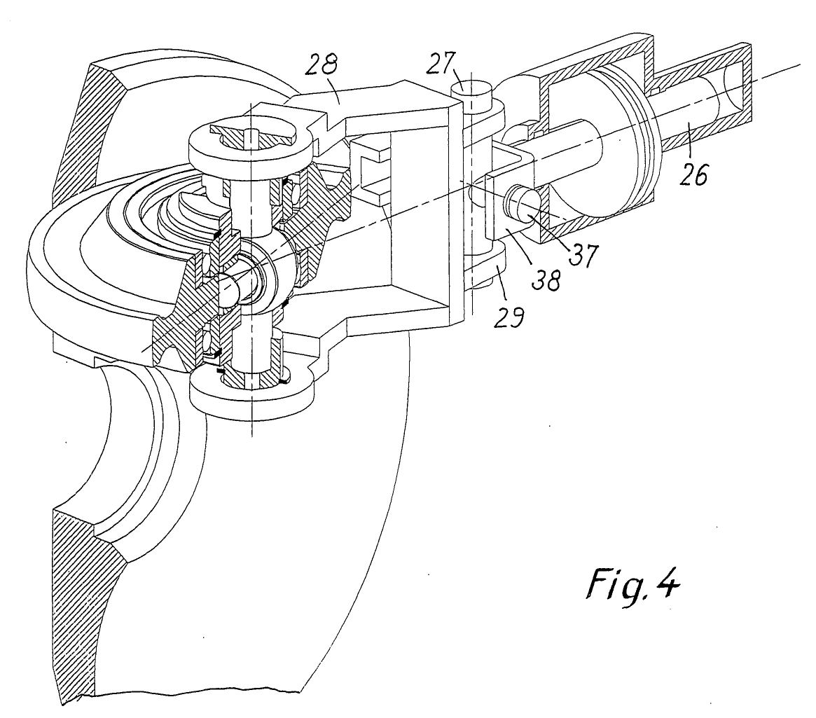

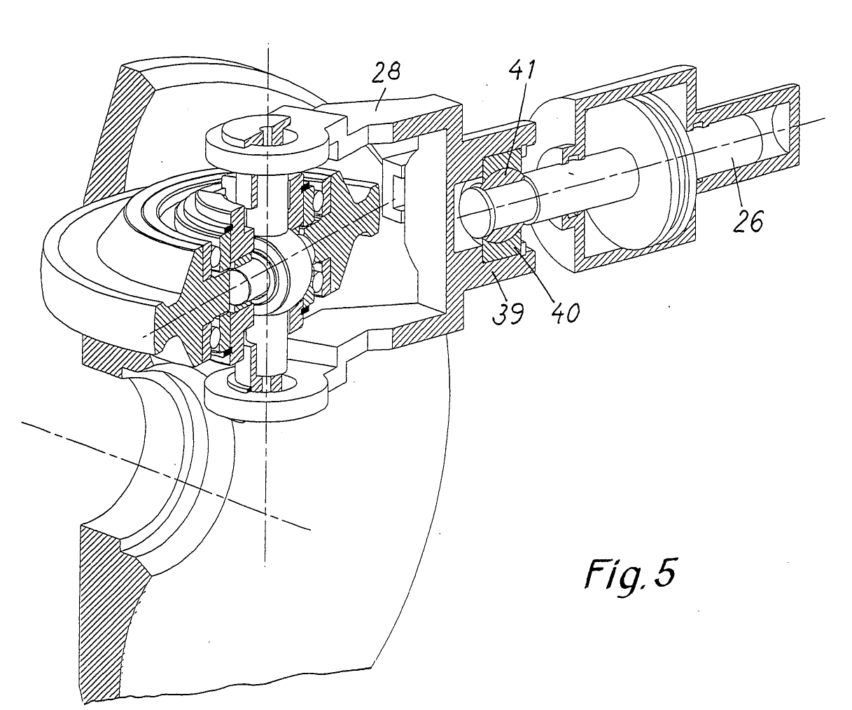

The second and third embodiment of a toroidal drive shown in FIGS. 4 and 5 differs from that shown in FIGS. 1-3, and described above, only in the nature of the linking of the piston shaft 26 to the fork 28.

In the embodiment shown in FIG. 4, the piston shaft 26 is not fastened directly to the pin 27 but is articulated to it. For this purpose the pin 27 is provided with a journal 37 coaxial with the guide pin 30, and a stirrup 38 is fastened to the piston shaft 26 and is pivotally joined to the guide pin 30 and the journal 37. In this way a cardan joint is created, so that the fork 28 can turn on two axes which are parallel and at right angles to the center plane M of the torus.

The third embodiment shown in FIG. 5 differs from that shown in FIG. 4 in that the cardan joint is replaced by a ball joint. A bearing body 40 with a concave bearing surface is inserted into a hub 39 of the fork 28, and in it a ball 41 pushed onto the piston shaft 26 is mounted for rotation. The fork 28 is therefore able to turn in all directions, but is prevented by the straight guide 31 from rotating about the axis of the piston shaft.

If the castor angle C, i.e., the angle between the axis of rotation defined by the pivot pin 33 and the center plane M of the torus, is changed, then it is necessary only to turn the pin 32 in the fork 28 and then tighten it again.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A continuously variable friction roll toroidal drive comprising:
two variator disks which can be turned about a common roll axis, wherein the variator disks each have a track that is part of a circumferential surface of a torus concentric with the common roll axis;
two or more rollers in contact with the tracks of the variator disks;
a housing for each roller, wherein the rollers are mounted for rotation in the respective housings;
a support associated with each housing, wherein the axis of rotation of each roller can turn on an axis which is inclined at an angle to a central plane of the torus;
a hydraulically operated piston to which each support is joined, wherein the direction of action of each support lies in the center plane of the torus; and
a turning body for each roller, wherein each roller is mounted for rotation on its turning body, and wherein the turning body is mounted for turning in the housing, while the axis of rotation of the turning body is inclined at the angle to the center plane of the torus.

2. The toroidal drive according to claim 1, wherein the housing includes a fork joined to the support and a pin joined for co-rotation with the support, and wherein the pin has journals projecting bilaterally whose common axis is inclined at the angle to the center plane of the torus, the turning body being mounted for rotation on the journals.

3. The toroidal drive according to claim 2, wherein the support includes a piston shaft, wherein the shaft is joined with the hydraulic piston, is guided for axial movement and is secured against rotation.

4. The toroidal drive according to claim 3, wherein the piston shaft is guided in a cylinder housing for a bilaterally driven piston.

5. The toroidal drive according to claim 4, wherein the housing is joined to the support by a joint whose axis lies in the center plane of the torus and is at a right angle to the direction of the action of the support.

6. The toroidal drive according to claim 4, wherein the housing is joined to the support by a cardan joint whose one axis lies in the center plane of the torus and is at a right angle to the direction of the action of the support and whose second axis is at a right angle to the center plane of the torus and to the direction of the action of the support .

7. The toroidal drive according to claim 4, wherein the housing is joined to the support through a ball joint.

8. The toroidal drive according to claim 7, wherein the pivot pin is joined for rotational adjustment, the adjustment axis of the pivot pin coinciding with the roll axis of the roller.

9. The toroidal drive according to claim 1, wherein the support includes a piston shaft, wherein the shaft is joined with the hydraulic piston, is guided for axial movement and is secured against rotation.

10. The toroidal drive according to claim 9, wherein the piston shaft is guided in a cylinder housing for a bilaterally driven piston.

11. The toroidal drive according to claim 1, wherein the housing is joined to the support by a joint whose axis lies in the center plane of the torus and is at a right angle to the direction of the action of the support.

12. The toroidal drive according to claim 1, wherein the housing is joined to the support by a cardan joint whose one axis lies in the center plane of the torus and is at a right angle to the direction of the action of the support and whose second axis is at a right angle to the center plane of the torus and to the direction of the action of the support.

13. The toroidal drive according to claim 1, wherein the housing is joined to the support through a ball joint.

14. The toroidal drive according to claim 2, wherein the pivot pin is joined for rotational adjustment, the adjustment axis of the pivot pin coinciding with the roll axis of the roller.
